(19) United States
(12) Patent Application Publication
(10) Pub. No.: US 2021/0125170 A1
(43) Pub. Date: Apr. 29, 2021

(54) RESTAURANT PAYMENT SYSTEMS AND METHODS THEREOF

(71) Applicant: Citadel Technology Group Incorporated, Windsor (CA)

(72) Inventors: Andrew Woodall, Windsor (CA); Liam Goodwin, Windsor (CA); Anthony Valente, Lasalle (CA); Adam Colborne, Windsor (CA)

(21) Appl. No.: 17/091,861

(22) Filed: Nov. 6, 2020

Related U.S. Application Data
(63) Continuation-in-part of application No. 17/083,570, filed on Oct. 29, 2020.
(60) Provisional application No. 62/927,400, filed on Oct. 29, 2019.

(51) Int. Cl. G06Q 20/32; G06Q 20/08; G06Q 30/04; G06Q 20/02; G06Q 40/00; G06Q 20/10; G06Q 20/04; G06K 9/00; G06K 9/03

(52) U.S. Cl. CPC G06Q 20/3224; G06Q 20/085; G06Q 30/04; G06Q 20/02; G06Q 40/12; G06F 3/04847; G06Q 20/047; G06K 9/00442; G06K 9/036; G06K 2209/01; G06Q 20/102

(57) ABSTRACT

Embodiments of the present disclosure are directed to systems and methods for a restaurant payment. The restaurant payment system includes a mobile computing device and an interface device communicatively coupled to the mobile computing device. The interface device includes a processing device, and a processor-readable storage medium in communication with the processing device storing one or more programming instructions that, when executed, cause the processing device to receive, by the mobile computing device, a location of a dining service, display, on the mobile computing device, a plurality of restaurants located within a predetermined radius of the determined location of the dining service, receive, by the mobile computing device, a bill for the dining experience, determine a plurality of information included on the bill, and display, on the mobile computing device, the plurality of information included on the bill.

### CROSS REFERENCE

This application is a continuation-in-part of U.S. patent application Ser. No. 17/083,570, filed on Oct. 29, 2020, and entitled “Restaurant Payment Systems and Methods Thereof”, which claims priority to the U.S. Provisional Patent Application Ser. No 62/927,400, filed on Oct. 29, 2019, and entitled “Restaurant Payment System” which is incorporated by reference herein in its entirety under 35 U.S.C. § 119(e).

### TECHNICAL FIELD

The present disclosure generally relates to payment systems and, more particularly, to systems and methods for mobile payment systems within restaurants.

### BACKGROUND

Dining experiences generally involve notifying a server that you would like the bill for the dinner. The diner then waits on the server to deliver the paper bill or a debit terminal, the diner reviews the bill, and either inserts a payment into a tab book or pays via the debit terminal. If the diner selects to pay with cash or via the tab book, then the diner must wait again for the server to pick up the tab book and payment. Then the diner waits for the server to process the payment, return with the receipt for payment and/or change. The diner may then later docket or make a transaction entry into some accounting or budgeting device or software. As such, the diner and server are generally waiting for the other to perform a task and the diner must remember to input the transaction entry.

Accordingly, a point of sale (POS) system that eliminates the need for the diner to insert a card into a restaurant owned debit terminal, eliminates the need for the server to pick up the tab book and payment or debit terminal after the transaction, and eliminates the need for the diner to make a transaction entry in an accounting ledger for the transaction is needed.

### SUMMARY

In one embodiment, a restaurant payment system is provided. The restaurant payment system includes a mobile computing device and an interface server device communicatively coupled to the mobile computing device. The interface server device includes a processing device, and a non-transitory, processor-readable storage medium in communication with the processing device. The non-transitory, processor-readable storage medium having one or more programming instructions that, when executed, cause the processing device to receive, by the mobile computing device, a location of a dining service, display, on the mobile computing device, a plurality of restaurants located within a predetermined radius of the determined location of the dining service, receive, by the mobile computing device, a bill for the dining experience, determine a plurality of information included on the bill, and display, on the mobile computing device, the plurality of information included on the bill.

In another embodiment, a method for a restaurant payment is provided. The method includes receiving, by a mobile computing device, a location of a dining service, displaying, on the mobile computing device, a plurality of restaurants located within a predetermined radius of the determined location of the dining service, receiving, by the mobile computing device, a bill for the dining experience, and determining, by an interface server device, an accuracy of the image using a plurality of predetermined factors. The method continues by determining, by the interface server device, a plurality of information included on the bill, displaying, on the mobile computing device, the plurality of information included on the bill, and displaying, on the mobile computing device, a slider that is movable by a user to select a tip amount. The tip amount changes a visual graphic of a total amount due.

In yet another embodiment, a system for wirelessly completing a restaurant payment is provided. The system includes a mobile computing device, a restaurant computing device communicatively coupled to the mobile computing device, and an interface server device communicatively coupled to the mobile computing device and the restaurant computing device. The interface server device includes a processing device and a non-transitory, processor-readable storage medium in communication with the processing device, the non-transitory, processor-readable storage medium having one or more programming instructions that, when executed, cause the processing device to receive, by the mobile computing device, a payment initiation, transmit, by the interface server device, a payment information, collect by the interface server device, a plurality of funds that correspond to the payment information less any fees, and transfer, by the interface server device, the plurality of funds that correspond to the payment information less any fees to the restaurant computing device.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts an illustrative computing network for a restaurant payment system according to one or more embodiments described and illustrated herein;

FIG. 2A schematically depicts an interface device from FIG. 1, further illustrating hardware and software components that may be used in the restaurant payment system according to one or more embodiments described and illustrated herein;

FIG. 2B schematically depicts a restaurant computing device from FIG. 1, further illustrating hardware and software components that may be used in the restaurant payment system according to one or more embodiments described and illustrated herein;

FIG. 2C schematically depicts a mobile electronic device from FIG. 1, further illustrating hardware and software components that may be used in the restaurant payment system according to one or more embodiments described and illustrated herein;

FIG. 3 depicts a flow diagram of an illustrative method of funding a payment according to one or more embodiments shown and described herein;

FIG. 4 depicts a flow diagram of an illustrative method of processing a payment according to one or more embodiments shown and described herein;

FIG. 5 schematically depicts an illustrative view of a login interface eliciting a unique identifier from a user according to one or more embodiments shown and described herein;

FIG. 6 schematically depicts an illustrative view of a home interface displaying data for a specific user according to one or more embodiments shown and described herein;

FIG. 7 schematically depicts an illustrative view of a settings interface according to one or more embodiments shown and described herein;

FIG. 8 schematically depicts an illustrative view of a restaurant selection interface based on a determined location of the user according to one or more embodiments shown and described herein;

FIG. 9 schematically depicts an illustrative view of a specific restaurant interface and scan receipt graphic according to one or more embodiments shown and described herein;

FIG. 10 schematically depicts an illustrative view of a specific restaurant interface and a take a picture graphic and upload picture from gallery graphic according to one or more embodiments shown and described herein;

FIG. 11 schematically depicts an illustrative view of a specific transaction interface according to one or more embodiments shown and described herein;

FIG. 12 schematically depicts an illustrative view of a transaction history interface according to one or more embodiments shown and described herein;

FIG. 13 schematically depicts an illustrative view of a payment interface according to one or more embodiments shown and described herein;

FIG. 14 schematically depicts an illustrative view of a confirmation payment interface according to one or more embodiments shown and described herein;

FIG. 15 schematically depicts an illustrative view of an unsuccessful payment notification interface according to one or more embodiments shown and described herein;

FIG. 16 schematically depicts an illustrative view of a successful payment notification interface according to one or more embodiments shown and described herein; and

FIG. 17 schematically depicts an illustrative view of a restaurant portal interface according to one or more embodiments shown and described herein.

### DETAILED DESCRIPTION

Embodiments of the present disclosure are directed to systems and methods for mobile restaurant payments. The system is configured to determine the location of a restaurant a user is present within, to read a scanned bill, to accept a payment and to process the payment including transferring the payment to the restaurant without the need for a server or the restaurant to intervene, and saved a finalized receipt that includes adjustable tip data. As such, the payment information of the user is not used in any restaurant point of sale equipment (i.e., registers, point of sale terminals, and/or the like). Accordingly, the likelihood of an undesirable adverse effect associated with the payment information is significantly reduced (i.e., identify theft of the payment information). That is, because the payment information is not used in the point of sale equipment of the restaurant, there is a greater security and theft control of the payment information using the mobile restaurant payment systems and methods described herein.

Further, the systems and methods for mobile restaurant payments provides real time reporting and analysis for the user based on a plurality of transactions completed using the mobile restaurant payment system and methods. For example, a predetermined number of previous transaction may be displayed to the user, a total monies spent for a given predetermined time period, restaurants visited by the user, and the like. As such, the mobile restaurant payment system and methods may be an accounting device to assist the user.

Various systems and methods for the mobile restaurant payment are described in detail herein.

As used herein, the term “communicatively coupled” means that coupled components are capable of exchanging data signals and/or electric signals with one another such as, for example, electrical signals via conductive medium, electromagnetic signals via air, optical signals via optical waveguides electrical energy via conductive medium or a non-conductive medium, data signals wirelessly and/or via conductive medium or a non-conductive medium and the like.

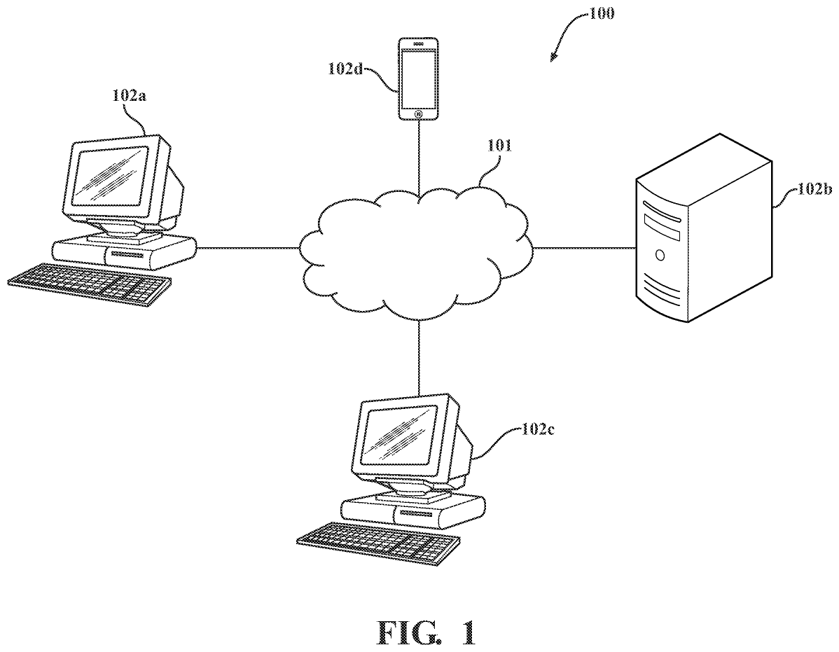

Referring now to the drawings, FIG. 1 depicts an illustrative computing network that depicts components for a system 100 for interacting with a user and a restaurant to process a payment, according to embodiments shown and described herein. As illustrated in FIG. 1, a computer network 101 may include a wide area network (WAN), such as the internet, a local area network (LAN), a mobile communications network, a public service telephone network (PSTN) a personal area network (PAN), a metropolitan area network (MAN), a virtual private network (VPN), and/or another network. The computer network 101 may generally be configured to electronically connect one or more computing devices and/or components thereof. Illustrative computing devices may include, but are not limited to, a restaurant computing device 102a, an interface server device 102b, an administrative computing device 102c and a mobile computing device 102d.

The restaurant computing device 102a may generally provide an interface between a restaurant and the other components connected to the computer network 101. It should be appreciated that there may be a plurality of restaurant computing devices 102a, including, in some embodiments, at least one for each restaurant connected to the network 101. In other embodiments, some restaurants may be more than one restaurant computing device 102a. The restaurant computing device 102a may be used to perform one or more user-facing functions, such as receiving one or more inputs from an employee (i.e., inputting an order, gathering a bill of sale, and the like) or transmitting data or information such as data related to inputting an order for a user, gathering a bill of sale, receiving data once a bill is paid, displaying billing information such as a transaction complete unique identifier, and the like. More specifically, the restaurant computing device 102a may be used to communicate between the restaurant and the user without the user actually using the restaurant's point of sale equipment to receive a bill for the meal and/or process the payment for the bill, as discussed in greater detail herein. The restaurant computing device 102a may include an employee interface that may be configured to transmit and receive a plurality of data related to the user such as the bill for the meal, payment successful or incomplete information and/or the like. The data may be received from and/or transmitted to the interface server device 102b and thus utilizes data received from the interface server device 102b when displaying the data on the employee interface, as described in greater detail herein.

Illustrative examples of the restaurant computing device 102a include a smartphone, a tablet, a personal computer, an Internet-connected user device (such as a smart watch, a fitness band, a personal assistant device, and the like), an Internet-connected consumer electronic device, and the like. In some embodiments, the restaurant computing device 102a may be a generic device that can be loaded with a software program, module, and/or the like to provide the functionality described herein. In other embodiments, the restaurant computing device 102a may be a specialized device that is particularly designed and configured to provide the functionality described herein. The components and functionality of the restaurant computing device 102a will be set forth in detail below.

Additionally, included in FIG. 1 is the administrative computing device 102c. In the event that the restaurant computing device 102a and/or the interface server device 102b requires oversight, updating, or correction, the administrative computing device 102c may be configured to provide the desired oversight, updating, and/or correction. The administrative computing device 102c may also be used to input additional data into a data storage portion of the interface server device 102b. For example, the administrative computing device 102c may input availability of restaurants that are connected to the network 101. Further, the administrative computing device 102c may receive data from interface server device 102b, such as the payment complete information for a particular transaction, a copy of the bill that is paid, a unique identifier for the completed payment, and the like.

The mobile computing device 102d may generally be used as an interface between a user and the other components connected to the computer network 101, and/or various other components communicatively coupled to the restaurant computing device 102a (such as components communicatively coupled via one or more networks to the mobile computing device 102d and/or the restaurant computing device 102a), whether or not specifically described herein. Thus, the mobile computing device 102d may be used to perform one or more user-facing functions, such as receiving one or more inputs from a user or providing information to the user. The mobile computing device 102d may also be used to input additional data into a data storage portion of the interface server device 102b. Illustrative examples of the mobile computing device 102d include a smartphone, a tablet, a personal computer, an Internet-connected user device (such as a smart watch, a fitness band, a personal assistant device, and the like), an Internet-connected consumer electronic device, and the like. In some embodiments, the mobile computing device 102d may be a generic device that can be loaded with a software program, module, and/or the like to provide the functionality described herein. In other embodiments, the mobile computing device 102d may be a specialized device that is particularly designed and configured to provide the functionality described herein. The components and functionality of the mobile computing device 102d will be set forth in detail below.

The interface server device 102b may receive electronic data and/or the like from one or more sources (e.g., the mobile computing device 102d, the restaurant computing device 102a, and/or one or more databases), direct operation of one or more other devices (e.g., the mobile computing device 102d and/or the restaurant computing device 102a), contain data relating to payment information, restaurant information, receipt interpretation, past transactions, contain information regarding accounting practices, and/or the like, and/or provide or transmit data to one or more sources (e.g., the mobile computing device 102d, the restaurant computing device 102a, and/or one or more databases). The components and functionality of the interface server device 102b will be set forth in detail below.

It should be understood that while the restaurant computing device 102a and the administrative computing device 102c are each depicted as a personal computer, the mobile computing device 102d as a smartphone, and the interface server device 102b is depicted as a server, these are nonlimiting examples. More specifically, in some embodiments, any type of computing device (e.g., mobile computing device, personal computer, server, etc.) may be used for any of these components. Additionally, while each of these computing devices is illustrated in FIG. 1 as a single piece of hardware, this is also merely an example. More specifically, each of the restaurant computing device 102a, the administrative computing device 102c, the mobile computing device 102d, and/or the interface server device 102b may represent a plurality of computers, servers, databases, mobile devices, components, and/or the like.

In addition, while the present disclosure generally relates to computing devices, the present disclosure is not limited to such. For example, various electronic devices that may not be referred to as computing devices but are capable of providing functionality similar to the computing devices described herein, may be used. Illustrative examples of electronic devices include, for example, certain electronic point of sale equipment, Internet-connected electronic devices (such as certain communications devices), and/or the like may be used.

In addition, it should be understood that while the embodiments depicted herein refer to a network of computing devices, the present disclosure is not solely limited to such a network. For example, in some embodiments, the various processes described herein may be completed by a single computing device, such as a non-networked computing device or a networked computing device that does not use the network to complete the various processes described herein.

In some embodiments, the network of computing devices may be a specialized network of devices that is particularly configured to provide the functionality described herein. Such a specialized network, by eliminating unnecessary components or functionality, may be able to operate more quickly and/or efficiently to determine a bill owed for a dining experience, process a payment for that bill, notify the restaurant of a successful payment, transfer funds to the restaurant, and save the transaction as a receipt that includes a digital tip and total amount for the user and the restaurant. As such, as used herein, a “bill” may be the bill provided from the restaurant with or without a tip included and a “receipt” may be the proof of the finalized transaction that may include a tip amount, total amount paid, and other information, such as, without limitation, an approval number, a type of payment (i.e., Visa®, MasterCard®, and the like), a date and time of the transaction, and/or the like. Moreover, such functionality, despite being wholly within one or more computing devices, provides real time payment processing and accounting practices to the user and the restaurant.

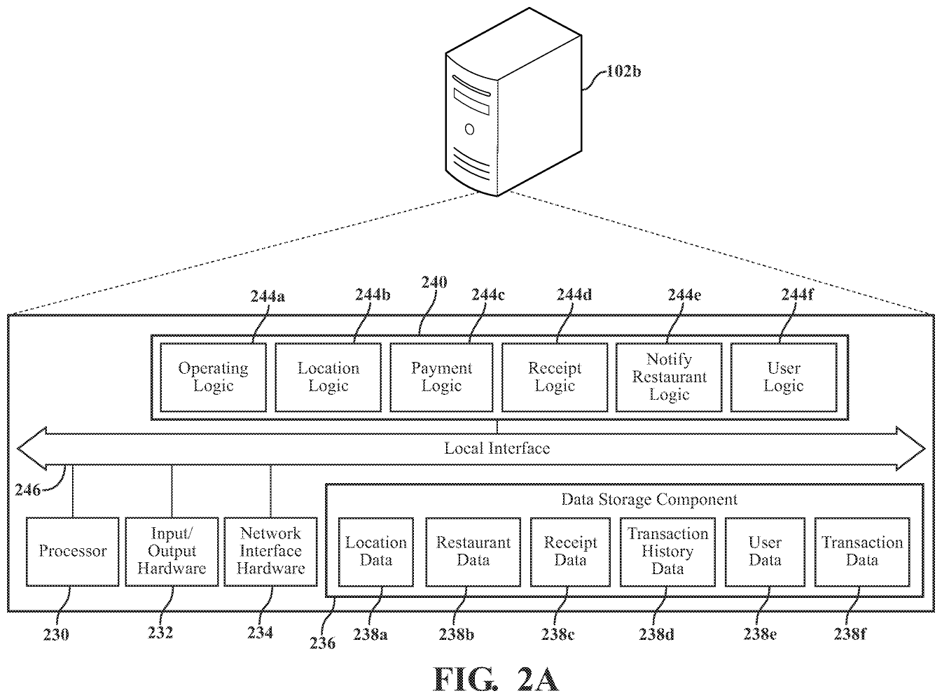

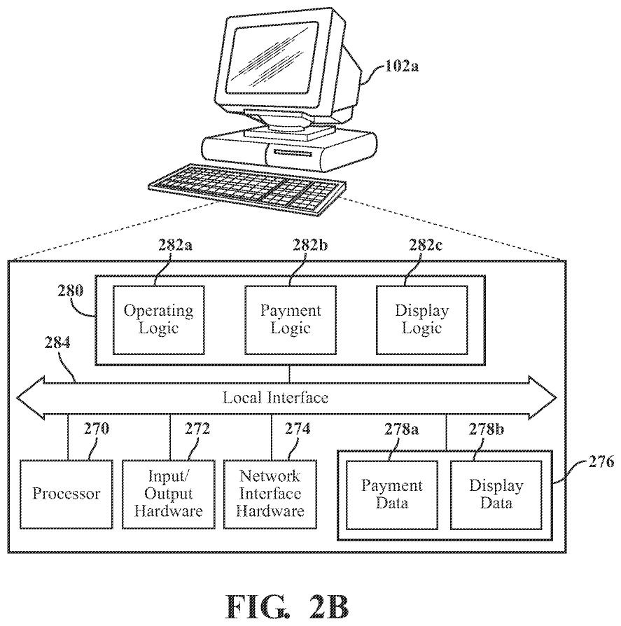

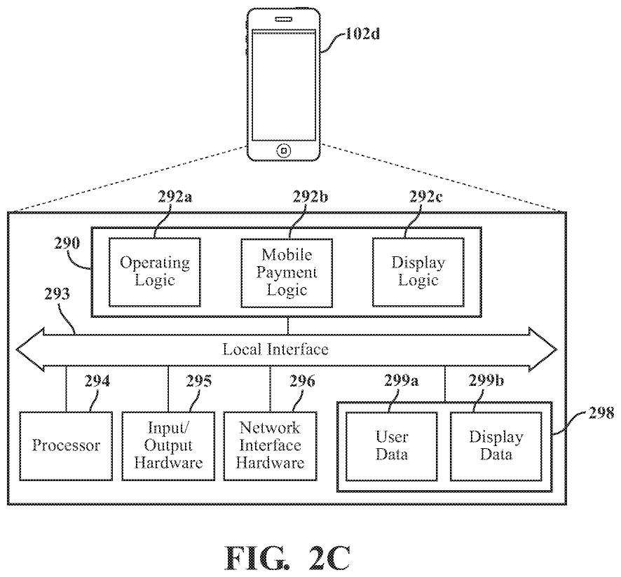

FIG. 2A depicts the interface server device 102b, further illustrating a system that identifies a location of a user, identifies a restaurant bill and payment thereof, and a digital tip and total amount for the user and the restaurant by utilizing hardware, software, and/or firmware, according to embodiments shown and described herein. The interface server device 102b may include a non-transitory, computer readable medium configured for identifying restaurants, identifying bills for a meal, and/or a payment for the meal embodied as hardware, software, and/or firmware, according to embodiments shown and described herein.

While in some embodiments, the interface server device 102b may be configured as a general purpose computer with the requisite hardware, software, and/or firmware, in other embodiments, the interface server device 102b may be configured as a special purpose computer designed specifically for performing the functionality described herein. For example, the interface server device 102b may be a specialized device that particularly identifies a location and a participating restaurant, a bill for a dining experience, and a payment for the bill, notifying the restaurant of the completed transaction, and/or the like. In a further example, the interface server device 102b may be a specialized device that determines the approval of funds, receives funds from a merchant company, and transfers the funds to the restaurant.

As also illustrated in FIG. 2A, the interface server device 102b may include a processor 230, input/output hardware 232, network interface hardware 234, a data storage component 236, which stores a location data 238a, a restaurant data 238b, a receipt data 238c, a transaction history data 238d, a user data 238e, and a transaction data 238f, and a memory component 240. The memory component 240 may be non-transitory computer readable memory. The memory component 240 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 240 may be configured to store an operating logic 244a, a location logic 244b, a payment logic 244c, a receipt logic 244d, a notify restaurant logic 244e, and a user logic 244f (each of which may be embodied as a computer program, firmware, or hardware, as an example). A local interface 246 is also included in FIG. 2A and may be implemented as a bus or other interface to facilitate communication among the components of the interface server device 102b. It should be understood that the processor 230, memory component 240 and various logic modules such as the operating logic 244a, the location logic 244b, the payment logic 244c, the receipt logic 244d, the notify restaurant logic 244e, and the user logic 244f may define a computer-program product for identifying a bill of a dining experience, processing a payment for the bill, notifying the restaurant of the successful payment processing, and transferring funds.

The processor 230 may include any processing component(s) configured to receive and execute instructions (such as from the data storage component 236 and/or memory component 240). The input/output hardware 232 may include a monitor, keyboard, mouse, printer, camera, microphone, speaker, and/or other device for receiving, sending, and/or presenting data. The network interface hardware 234 may include any wired or wireless networking hardware, such as a modem, LAN port, wireless fidelity (Wi-Fi) card, WiMAX card, mobile communications hardware, and/or other hardware for communicating with other networks and/or devices.

It should be understood that the data storage component 236 may reside local to and/or remote from the interface server device 102b and may be configured to store one or more pieces of data for access by the interface server device 102b and/or other components, identify a bill of a dining experience, process a payment for the bill, notify the restaurant of the successful payment processing, and transfer the funds. As illustrated in FIG. 2A, the data storage component 236 stores a location data 238a. As mentioned above, the location data 238a may include data related to the location of the user and data related to a plurality of restaurants located within a predefined radius of the determined location. As such, restaurants that are connected to the network 101 (FIG. 1) (i.e., that are subscribers), may be visually provided to the user via the mobile computing device 102d (FIG. 1) based on the determined location. In some embodiments, the predefined radius of the determined location may be any radius, such as 1 mile or 1 kilometer. In other embodiments, the radius of the determined location may be greater or less of a distance than 1 mile or 1 kilometer. Further, the determined location may be based on global positioning services that are built into the mobile computing device 102d (FIG. 1), through internet protocol (IP) addresses, and/or the like.

The restaurant data 238b stores data related to the restaurant such as an “about us” abstract that discuss the restaurant, menu information, average prices, and/or the like. Further, the restaurant data 238b may store information regarding the location of the restaurant, reservation data, and the like. The receipt data 238c may contain data relating to the specific bill from the dining experience. The bill may be electronically provided by the restaurant, such as by a server, or may be a hard copy bill that is delivered to the user, who then scans the bill using the mobile computing device 102d (FIG. 1), which is then interpreted and stored in the receipt data 238c. A tip amount may be added to complete the sale and then the bill is saved as a receipt of the total purchase.

The transaction history data 238d may include a history of a plurality of specific transactions. The history may be a predetermined number of transactions in which a payment was made using the mobile electronic device 102d (FIG. 1). In some embodiments, the predetermined number of transactions is 10. In other embodiments, the predetermined number of transactions may be more or less than 10. As such, the predetermined number of transactions stored in the transaction history data 238d provides the user with a way to track a history of payments to reconcile with a bank, to track totals of monies spent, and the like.

The user data 238e may include data relating to the specific user and payment information of the user. It should be appreciated that there may be a plurality payment information assigned to each user. Further, the payment information may be encrypted and not contain the actual user's payment information but works with the mobile computing device 102d (FIG. 1) to process the payment information via the merchant company and then transfer the funds, as discussed in greater detail herein. For example, to minimize undesirable security breaches such as identity theft, the actual payment data (i.e., the actual numbers of the card, expiration date and/or security code) are not transmitted or stored on the interface server device 102b but instead the mobile computing device 102d (FIG. 1) and the interface server device 102b worked together to process the payment.

The transaction data 238f includes data related to the actual approval of the transaction, the merchant company, and the restaurant to transfer the funds. For example, the user uses the mobile computing device 102d (FIG. 1) to pay a bill at the participating restaurant, the interface device and the mobile computing device 102d (FIG. 1) work together to process a payment using a payment type supplied by the user to a merchant company, which is provided with an approved transaction ID, which is then provided to the restaurant and a completed transaction. The transaction data 238f further includes data relating to the payment of funds received from the merchant company and then transferred to the restaurant, minus any fees, as discussed in greater detail herein. As such the interface server device 102b creates an accounting ledger for each transaction.

Included in the memory component 240 are the operating logic 244a, the location logic 244b, the payment logic 244c, the receipt logic 244d, the notify restaurant logic 244e, and the user logic 244f. The operating logic 244a may include an operating system and/or other software for managing components of the interface server device 102b. The location logic 244b may contain programming instructions to determine a location of the user and a plurality of restaurants located within a predetermined radius of the user and/or the mobile computing device 102d (FIG. 1). The location logic 244b may use information and/or data from the location to display to the user a plurality of restaurant information. For example, information about the restaurant itself, menu information, average prices, the location of the restaurant, reservation data, and/or the like. It should be appreciated that, in some embodiments, the location logic 244b may use social media platforms, search engines, and the like to display the information about the restaurants. In other embodiments, the location logic 244b may use saved information or data that may be provided or updated by the restaurant itself to display the information about the restaurants. As such, the location logic 244b may transmit data to the mobile computing device 102d, the restaurant computing device 102a, and the like, so that the data or information about the plurality of restaurants within the predetermined radius may be displayed, as discussed in greater detail herein.

The payment logic 244c may contain programming instructions to process the payment through a merchant company, receive funds from the merchant company, minus any fees, and then transfer the funds to the restaurant, minus any additional fees, as discussed in greater detail herein. The payment logic 244c may also update the transaction history for the user to view past transactions. The receipt logic 244d may contain programming instructions to receive the specific bill from the dining experience for the user. The bill may be electronically provided by the restaurant, such as by a server employee, or may be a hard copy bill that is delivered to the user, who then scans the bill using the mobile computing device 102d (FIG. 1). The bill is then interpreted, using optical character recognition (OCR) algorithm from the scanned image. It should be appreciated that the OCR algorithm, as used herein, may be an electronic or mechanical conversion of images of typed, handwritten or printed text into machine-encoded text, whether from a scanned document, a photo of a document, a scene-photo or from subtitle text superimposed on an image. Once the bill is determined, the user may add a tip amount, which changes the total. A receipt is then created to include the subtotal, taxes and tip amount and stored in the data storage component 236, as discussed in greater detail herein.

The notify restaurant logic 244e may contain programming instructions to notify the restaurant of the specific approved transaction. In some embodiments, the notification may be displayed on the restaurant computing device 102a (FIG. 1) and may be within a user interface. In other embodiments, the notification may be an alert or text to the server employee or any other alert to any employee or computer connected to the network 101 (FIG. 1). The user logic 244f may contain programming instructions to encrypted the user payment and work with the mobile computing device 102d (FIG. 1) to process the payment.

It should be understood that the components depicted in FIG. 2A are merely illustrative and are not intended to limit the scope of this disclosure. More specifically, while the components in FIG. 2A are illustrated as residing within the interface server device 102b, this is a nonlimiting example. In some embodiments, one or more of the components may reside external to the interface server device 102b. Similarly, while FIG. 2A is directed to the interface server device 102b, other components such as the restaurant computing device 102a, the administrative computing device 102c and/or the mobile computing device 102d may include similar hardware, software, and/or firmware.

FIG. 2B depicts the restaurant computing device 102a further illustrating a system that interacts with the interface server device 102b to transmit a bill and/or receive a payment thereof by utilizing hardware, software, and/or firmware, according to embodiments shown and described herein. In addition, the restaurant computing device 102a may include a non-transitory, computer readable medium configured for displaying and transmitting a data initiated by a user embodied as hardware, software, and/or firmware, according to embodiments shown and described herein.

While, in some embodiments, the restaurant computing device 102a may be configured as a general purpose computer with the requisite hardware, software, and/or firmware, in other embodiments, the restaurant computing device 102a may be configured as a special purpose computer designed specifically for performing the functionality described herein. For example, the restaurant computing device 102a may be a specialized device that displays a user interface for inputting the bill, for receiving a notification of a payment for the bill thereof, for commuting with other devices on the network 101 (FIG. 1), and/or the like, as discussed in greater detail herein.

As also illustrated in FIG. 2B, the restaurant computing device 102a may include a processor 270, input/output hardware 272, network interface hardware 274, data storage component 276, which stores a database of payment data 278a and display data 278b, and a memory component 280. The memory component 280 may be non-transitory computer readable memory. The memory component 280 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 280 may be configured to store operating logic 282a, payment logic 282b, and display logic 282c (each of which may be embodied as a computer program, firmware, or hardware, as an example). A local interface 284 is also included in FIG. 2B and may be implemented as a bus or other interface to facilitate communication among the components of the restaurant computing device 102a.

The processor 270 may include any processing component(s) configured to receive and execute instructions (such as from the data storage component 276 and/or memory component 280). The input/output hardware 272 may include a monitor, keyboard, mouse, printer, camera, microphone, speaker, and/or other device for receiving, sending, and/or presenting data. The network interface hardware 274 may include any wired or wireless networking hardware, such as a modem, LAN port, wireless fidelity (Wi-Fi) card, WiMAX card, mobile communications hardware, and/or other hardware for communicating with other networks and/or devices.

It should be understood that the data storage component 276 may reside local to and/or remote from the restaurant computing device 102a and may be configured to store one or more pieces of data for access by the restaurant computing device 102a and/or other components, store data that may be received from an external device (e.g., the interface server device 102b) such as the payment data 278a, and/or store data to be displayed. As illustrated in FIG. 2B, the data storage component 276 stores a database of payment data 278a. The payment data 278a may include data related to a payment for a particular bill such as a transaction ID that corresponds to a successful payment data received from an external device (i.e., the interface server device 102b). The display data 278b may include data relating to the data to be displayed. For instance, the display data 278b may include a user interface to display data received from the interface server device 102b.

Included in the memory component 280 are the operating logic 282a, payment logic 282b, and display logic 282c. The operating logic 282a may include an operating system and/or other software for managing components of the restaurant computing device 102a. The payment logic 282b may contain programming instructions to send bills for dining services electronically, to receive payment information, to receive funds, and/or the like. The payment logic 282b may be configured to compile, organize, transmit, and/or display payment data, such that the interface server device 102b may analyze or provide the payment data for the user interface to display or a display device of the restaurant computing device 102a.

The display logic 282c may display a graphical user interface usable by a user of the restaurant computing device 102a to provide choices and/or selections, to display visualizations of a plurality of metadata associated with the bills, receipts, payments, and the like. The display logic 282c may generally be configured to display information on a display of the restaurant computing device 102a. The functionalities of the operating logic 282a, the payment logic 282b, and the display logic 282c will be described in further detail below.

It should be understood that the components depicted in FIG. 2B are merely illustrative and are not intended to limit the scope of this disclosure. More specifically, while the components in FIG. 2B are illustrated as residing within the restaurant computing device 102a, this is a nonlimiting example. In some embodiments, one or more of the components may reside external to the restaurant computing device 102a. Similarly, while FIG. 2B is directed to restaurant computing device 102a, other components such as the administrative computing device 102c and/or the mobile computing device 102d may include similar hardware, software, and/or firmware.

FIG. 2C depicts the mobile computing device 102d further illustrating a system that interacts with the interface server device 102b to identify a location of a user, identify a restaurant bill, and determine and approve a payment thereof by utilizing hardware, software, and/or firmware, according to embodiments shown and described herein. In addition, the mobile computing device 102d may include a non-transitory, computer readable medium configured for displaying and transmitting a data initiated by a user embodied as hardware, software, and/or firmware, according to embodiments shown and described herein.

While, in some embodiments, the mobile computing device 102d may be configured as a general purpose computer with the requisite hardware, software, and/or firmware, in other embodiments, the mobile computing device 102d may be configured as a special purpose computer designed specifically for performing the functionality described herein. For example, the mobile computing device 102d may be a specialized device that displays a user interface to determine a bill for dining services, process a payment for the bill and/or transfer funds, and the like, as discussed in greater detail herein.

As also illustrated in FIG. 2C, the mobile computing device 102d may include a processor 294, input/output hardware 295, network interface hardware 296, data storage component 298, which stores a database of user data 299a and a display data 299b, and a memory component 290. The memory component 290 may be non-transitory computer readable memory. The memory component 290 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 290 may be configured to store operating logic 292a, mobile payment logic 292b, and display logic 292c (each of which may be embodied as a computer program, firmware, or hardware, as an example). A local interface 293 is also included in FIG. 2C and may be implemented as a bus or other interface to facilitate communication among the components of the administrative computing device 102c.

The processor 294 may include any processing component(s) configured to receive and execute instructions (such as from the data storage component 298 and/or memory component 290). The input/output hardware 295 may include a monitor, keyboard, mouse, printer, camera, microphone, speaker, and/or other device for receiving, sending, and/or presenting data. The network interface hardware 296 may include any wired or wireless networking hardware, such as a modem, LAN port, wireless fidelity (Wi-Fi) card, WiMAX card, mobile communications hardware, and/or other hardware for communicating with other networks and/or devices.

It should be understood that the data storage component 298 may reside local to and/or remote from the mobile computing device 102d and may be configured to store one or more pieces of data for access by the mobile computing device 102d and/or other components, store data that may be received from an external device (e.g., the interface server device 102b) such as the user data 299a, and/or store data to be displayed.

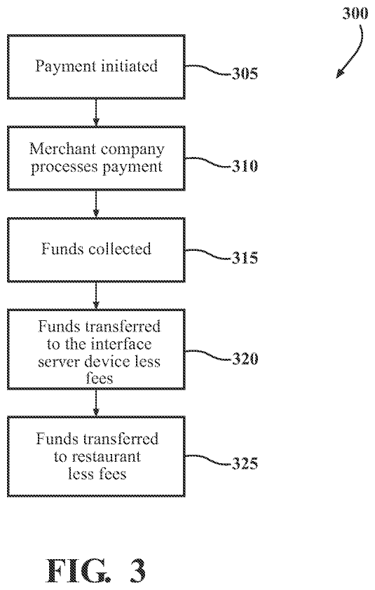

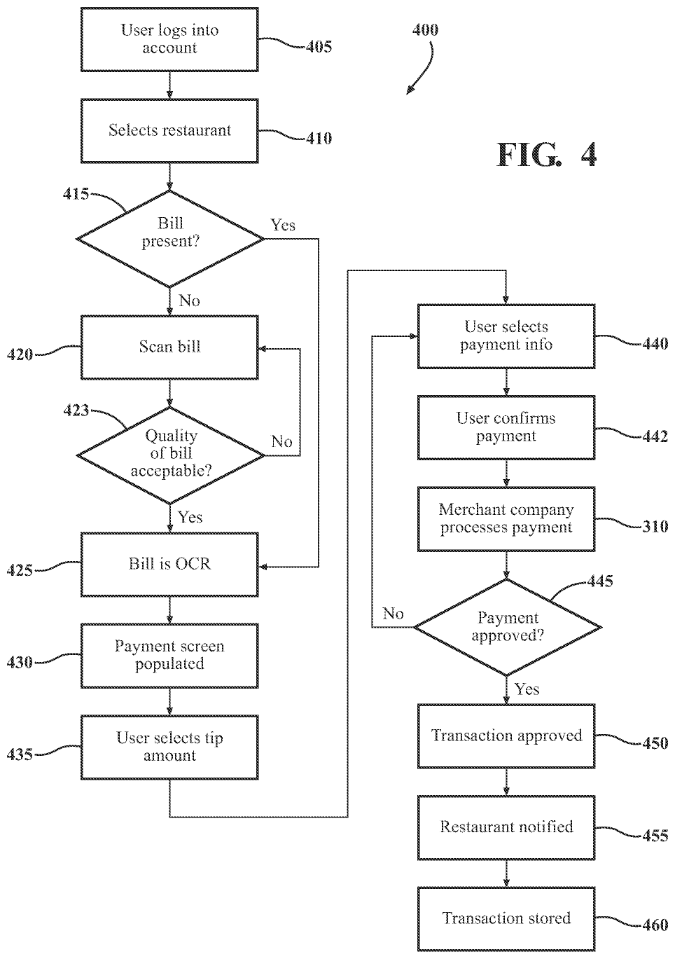

As illustrated in FIG. 2C, the data storage component 298 stores the database of the user data 299a and the display data 299b. As mentioned above, the user data 299a may be data relating to the specific user and payment information of the user. It should be appreciated that there may be a plurality payment information assigned to each user. Further, the payment information may be encrypted such that the actual user's payment information is stored within the data storage component 298 of the mobile computing device 102d to process the payment information via the merchant company and then transfer the funds, as discussed in greater detail herein. For example, to minimize undesirable security breaches such as identity theft, the actual payment data (i.e., the actual numbers of the card, expiration date and/or security code) are stored on the mobile computing device 102d and are not transmitted or stored on the interface server device 102b, but instead the mobile computing device 102d and the interface server device 102b worked together to process the payment, such as the process described herein with respect to FIGS. 3-4. Further, as mentioned above, the display data 299b includes data to be displayed such as data related to a user interface that may use an application or other mobile user interface to display information to the user.

Included in the memory component 290 are the operating logic 292a, mobile payment logic 292b, and display logic 292c. The operating logic 282a may include an operating system and/or other software for managing components of the mobile computing device 102d. The mobile payment logic 292b may contain programming instructions to facilitate a payment for the bill incurred during a dining experience. As such, the mobile payment logic 292b may be configured to compile, organize, transmit, and/or display the payment information, transaction approval information, transaction denial information, and the like, that is transmitted to a merchant company in association with the interface server device 102b to process the payment.

The display logic 292c may display a graphical user interface usable by a user of the mobile computing device 102d to provide a payment choice, a bill selection, to display visualizations of a plurality of metadata associated with the selected choices, and to display the result of the metadata associated with the selected choices. The display logic 292c may generally be configured to display information on a display of the mobile computing device 102d. The functionalities of the operating logic 292a, the mobile payment logic 292b, and the display logic 292c will be described in further detail below.

It should be understood that the components depicted in FIG. 2C are merely illustrative and are not intended to limit the scope of this disclosure. More specifically, while the components in FIG. 2C are illustrated as residing within the mobile computing device 102d, this is a nonlimiting example. In some embodiments, one or more of the components may reside external to the mobile computing device 102d. Similarly, while FIG. 2C is directed to the mobile computing device 102d, other components such as the restaurant computing device 102a may include similar hardware, software, and/or firmware.

Referring now to FIG. 3, a flow diagram that graphically depicts an illustrative method 300 of funding a payment is provided. Although the steps associated with the blocks of FIG. 3 will be described as being separate tasks, in other embodiments, the blocks may be combined or omitted. Further, while the steps associated with the blocks of FIG. 3 will described as being performed in a particular order, in other embodiments, the steps may be performed in a different order.

As shown in FIG. 3, the method 300 may begin with a payment initiation, at block 305, that is initiated by the user via the mobile computing device 102d. Once the payment is initiated by the user, a merchant company processes the payment, at block 310, and the funds are collected, at block 315. The funds collected are then transferred, via the interface server device 102b, at block 320, less any fees from the merchant company, and the funds are then transferred to the restaurant, at block 325, less any fees from the merchant company and the fees of the payment through the disclosed payment system.

Referring now to FIG. 4, a flow diagram that graphically depicts an illustrative method 400 of funding a payment is provided. Although the steps associated with the blocks of FIG. 4 will be described as being separate tasks, in other embodiments, the blocks may be combined or omitted. Further, while the steps associated with the blocks of FIG. 4 will described as being performed in a particular order, in other embodiments, the steps may be performed in a different order.

As shown in FIG. 4, the method 400 may begin with the user logs into their account, at block 405. Within the home screen, the user selects a restaurant, at block 410. It should be appreciated that the restaurants displayed on the home page may be a plurality of restaurants that are located within a predetermined radius of the user based on a determined location of the user at the login. Once the restaurant is selected, the system determines whether the bill for the meal is present, at block 415. The bill may be present automatically be the restaurant electronically sending the bill to the user. If the bill is not present, the user may scan the bill using the mobile electronic device, at block 420. The quality of the scanned image is determined, at block 423, and if the quality of the bill is below a predetermined threshold based on predetermined factors, the user is prompted to scan the bill again, at block 420.

The predetermined factors may include clarity of the image, quality of the image, light and darkness of the image, and the like. The predetermined threshold, may be, for example, 90 percent. If the quality meets the predetermined level, at block 423, then the bill is subjected to an OCR algorithm to determine the bill information, at block 425. At block 430, regardless of whether the bill is electronically provided or the bill is interpreted using the OCR algorithm, the payment screen is populated, at block 430. At block 435, the user selects a tip amount to add to the bill and selects payment information, at block 440. The payment information may be a new card or saved card information that is stored on the mobile computing device 102d.

At block 442, the user confirms the payment and the merchant company processes the payment, at block 310. The system determines whether the payment is approved, at block 445. If the payment is not approved, the user is prompted to select payment information at block 440. In some embodiments, this may mean that the user has to enter a new or different card details. In other embodiments, the payment may be tried again with the same card information. On the other hand, if the payment is approved, the user is notified of the transaction approval, at block 450, via the mobile computing device 102d. Further, the restaurant is notified of the approval, at block 455. The restaurant may be notified by an e-mail, a message, a notification on a user interface of the restaurant computing device 102a, and/or the like. At block 460, the transaction is stored under the user on the interface server device 102b, at block 460.

Referring now to the illustrative methods 300, 400 of FIGS. 3-4, it should be appreciated that the illustrative methods 300, 400 allow for the payment to be processed without undesirable accounting liability to the restaurant and/or to the operator of the system 100 (FIG. 1) should a transaction be started, but not approved or an interrupted transaction (i.e., loss of connectivity). Further, it should be appreciated that each of the plurality of restaurants may pay a monthly subscription fee to the operator of the system 100 (FIG. 1) in addition to, or in place of a per transaction fee, such as a convenience or compliance fee. As such, the user of the mobile computing device 102d is not subject to a fee to use the service.

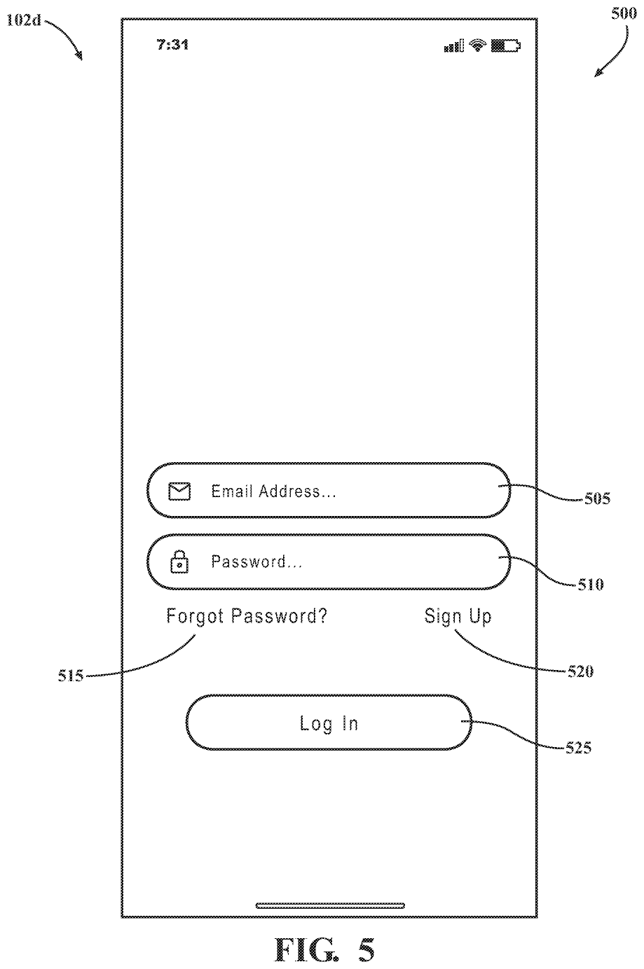

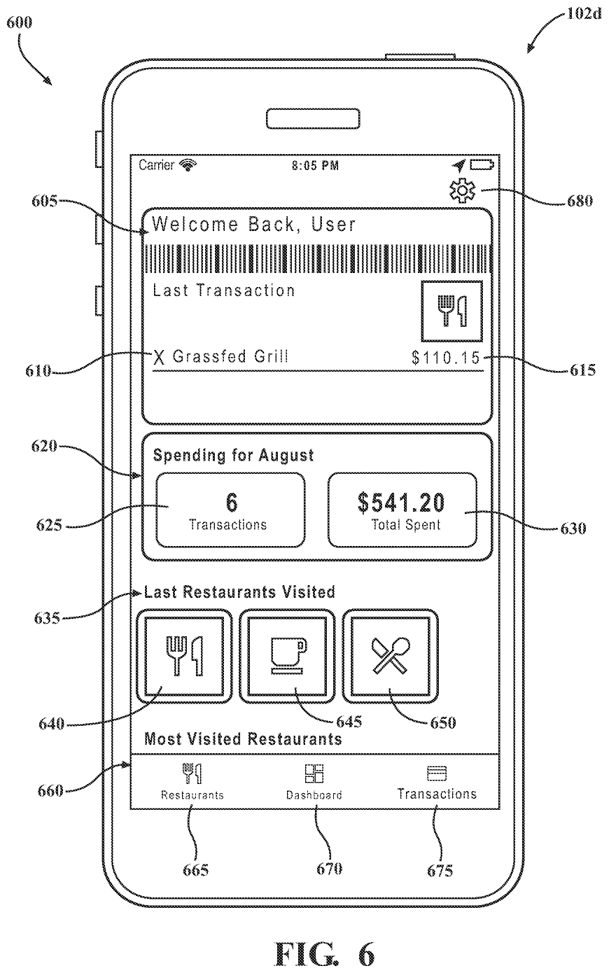

Referring now to FIG. 5, an illustrative view of a login interface 500 displayed on the mobile computing device 102d eliciting a unique identifier from a user is schematically depicted. The login interface 500 requires the user to enter a username 505 and password 510 and select a log in graphic 525. The mobile computing device 102d communicates with the interface server device 102b, and the data storage component 236 to verify the username and password. Once verified, a home interface 600 (FIG. 6) is displayed. The login interface 500 further includes a forgot password graphic 515 and a signup graphic 520. The signup graphic is a link for the user to initially save the user data into the data storage component 236 of the interface server device 102b.

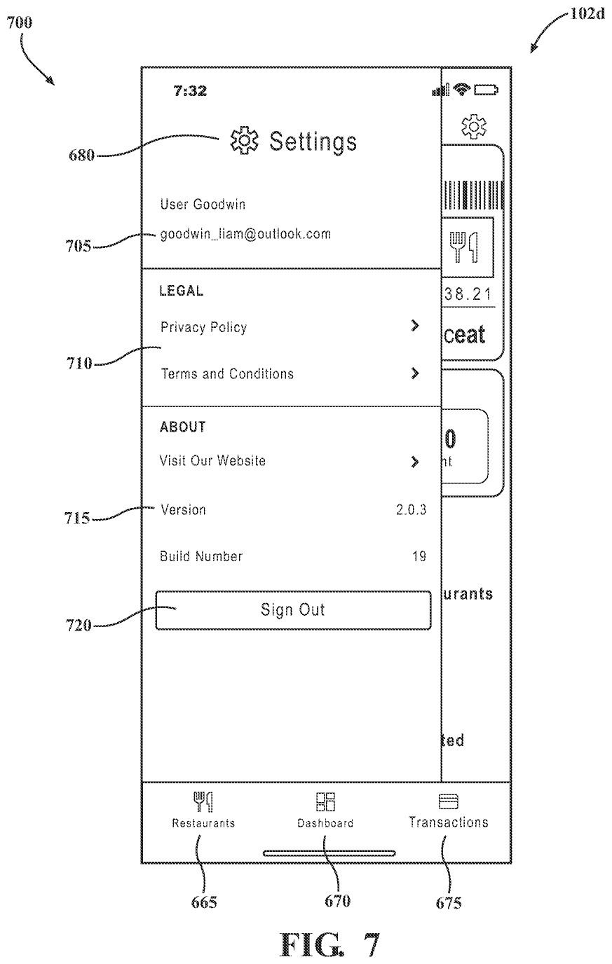

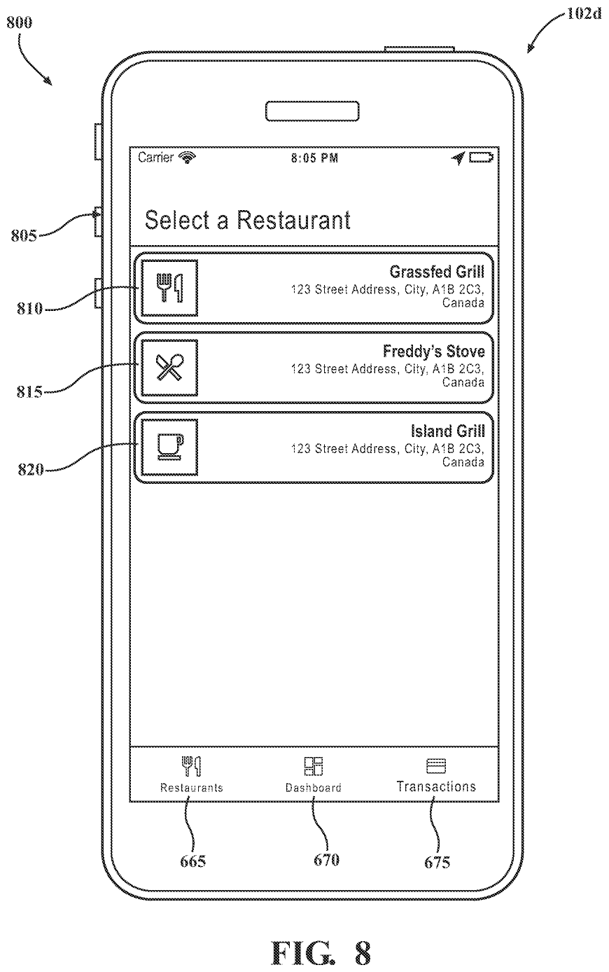

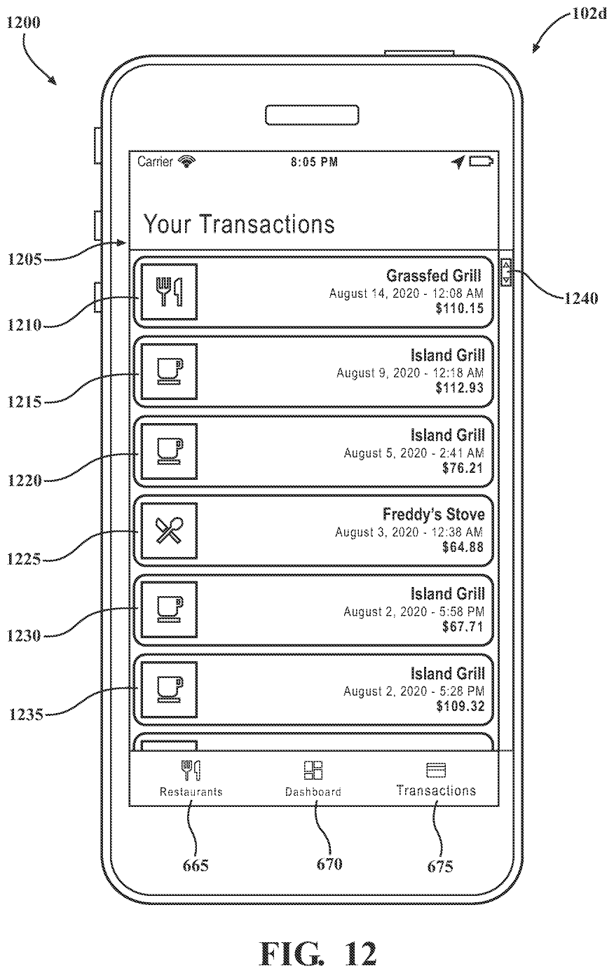

Referring now to FIG. 6, an illustrative view of the home interface 600 displayed on the mobile computing device 102d is schematically depicted. The home interface 600 provides a welcome portion 605 that includes a section to provide the user with an ability to view a last restaurant 610 and last transaction made 615, which may include a price and where purchased (i.e., store name). Further, the home interface 600 may display a monthly accounting 620, which includes a number of transactions 625 and total monies spent 630 for a desired month. In some embodiments, this may be a daily total, a weekly total, and/or an annual total. Further, the home interface 600 may provide a shortcut checkout to the one of the last three restaurants visited 635 by the user using a quick link graphic 640, 645, 650. Further, the home interface 600 includes a quick graphic link 660, which includes a restaurant graphic 665 to direct the user to the restaurant selection interface 800 (FIG. 8), a dashboard graphic 670 to direct the user to a dashboard, and transaction history graphic 675 to direct the user to a transaction history interface 1200 (FIG. 12). It should be understood that the data for the home interface 600 may be stored and retrieved from the interface server device 102b, the mobile computing device 102d, and/or the like. In addition, the home interface 600 includes a settings graphic link 680 that directs the user to a settings interface 700 (FIG. 7).

Referring to FIG. 7, an illustrative view of the settings interface 700 displayed on the mobile computing device 102d is schematically depicted. The settings interface 700 includes a graphic of the user name 705, a legal section 710 that may include a privacy policy and/or terms and conditions, an about section 715 and a sign out graphic 720. The about section 715 may include a link to visit a webpage of the developer, a version indicator and/or a build number. Further, the settings interface 700 includes the restaurant graphic 665, the dashboard graphic 670, and the transaction history graphic 675. It should be understood that the data for the settings interface 700 may be stored and retrieved from the interface server device 102b, the mobile computing device 102d, and/or the like.

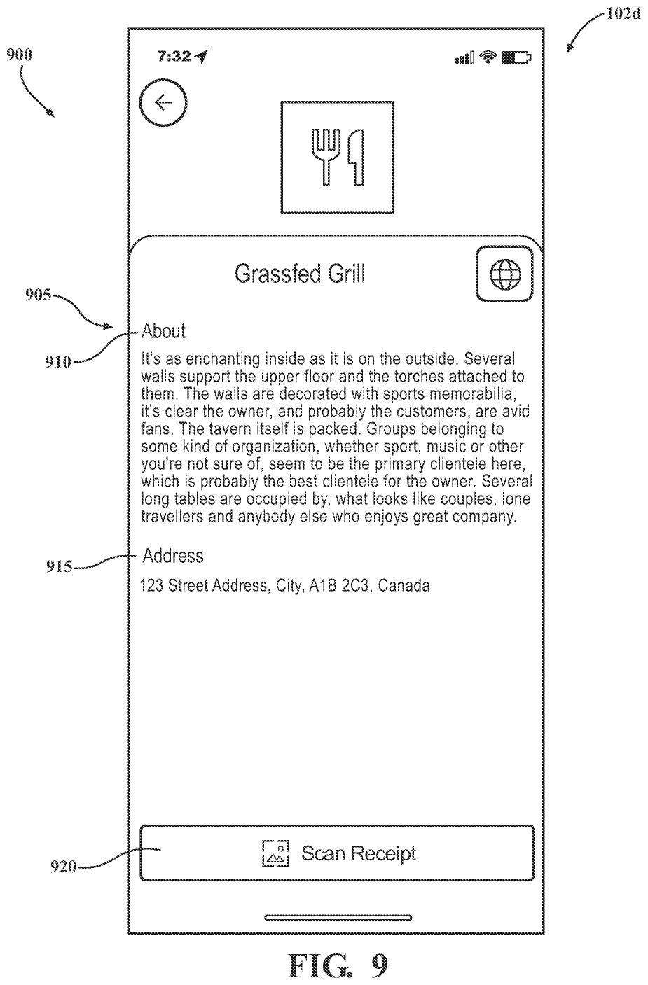

Referring to FIG. 8, an illustrative view of a restaurant selection interface 800 displayed on the mobile computing device 102d that is based on a determined location of the user is schematically depicted. The restaurant selection interface 800 is configured to display specific restaurants 805 that subscribe or are active within the system 100 and may be located within a predefined radius of the user's current location or where the user is wanting to dine. The name of each restaurant 810, 815, 820 that is within the predetermined radius may be displayed along with other restaurant information. For example, a logo of the restaurant, a short description of the restaurant, a map of the restaurant, and an address of the restaurant, may be displayed. It is appreciated that the restaurant displayed may be determined based on the current location of the user if within the restaurant or displayed within a radius of the user's current location and the user selects the restaurant from a list generated by the user's location. Once a restaurant is selected, either by the user or based on user current location, the restaurant interface 900 (FIG. 9) is displayed.

Referring to FIG. 9, an illustrative view of a first embodiment of the restaurant interface 900 displayed on the mobile computing device 102d is schematically depicted. The restaurant interface 900 includes details about the restaurant, such as an about section 910, the address 915 and a scan receipt graphic button 920, which initializes the mobile computing device 102d to prepare to scan the bill from the restaurant.

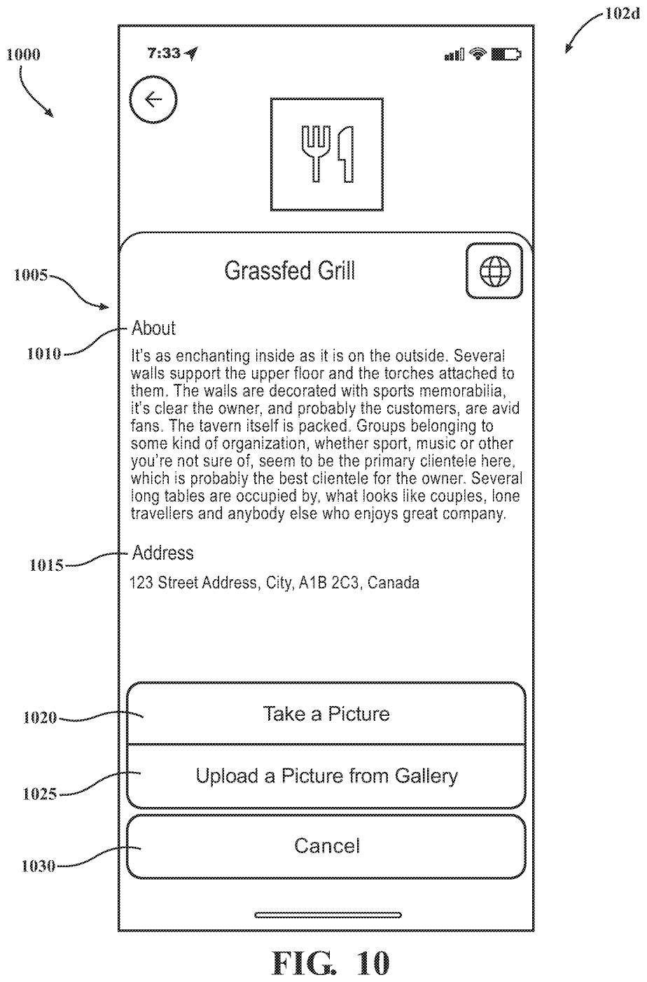

Referring to FIG. 10, an illustrative view of a second embodiment of a restaurant interface 1000 displayed on the mobile computing device 102d is schematically depicted. The restaurant interface 1000 includes details about the restaurant, such as an about section 1010, the address 1015, a take a picture graphic button 1020, an upload a picture from gallery graphic 1025 and a cancel graphic 1030. The take a picture graphic button 1020 and/or the upload a picture from gallery graphic 1025 may permit the user to take a picture of the bill and/or upload a picture of the bill and then the restaurant interface 900 and the scan receipt graphic button 920 (FIG. 9) may be used to OCR the bill.

That is, in some embodiments, the user uses a camera built into the mobile computing device 102d to capture an image of a bill provided by the restaurant. Once an image of the bill is captured, the image is uploaded or transferred to the interface server device 102b via the network 101. At the interface server device 102b, the image is altered to reduce overall file size, brighten the image, and increase the sharpness. The image is then subjected to an algorithm to determine the accuracy of the scan based on a plurality of predetermined factors. The predetermined factors may include clarity of the image, quality of the image, light and darkness of the image, and the like. If the scan accuracy is not above a predetermined percentage, such as, without limitation, 90 percent, the image may be denied and the user may be alerted to capture a new image and upload the new image with better clarity, lighting, quality, and the like. The image is also subjected to Optical Character Recognition (OCR) algorithm to read the image of the bill to determine the tax amount, subtotal price or amount, and total amount from the bill.

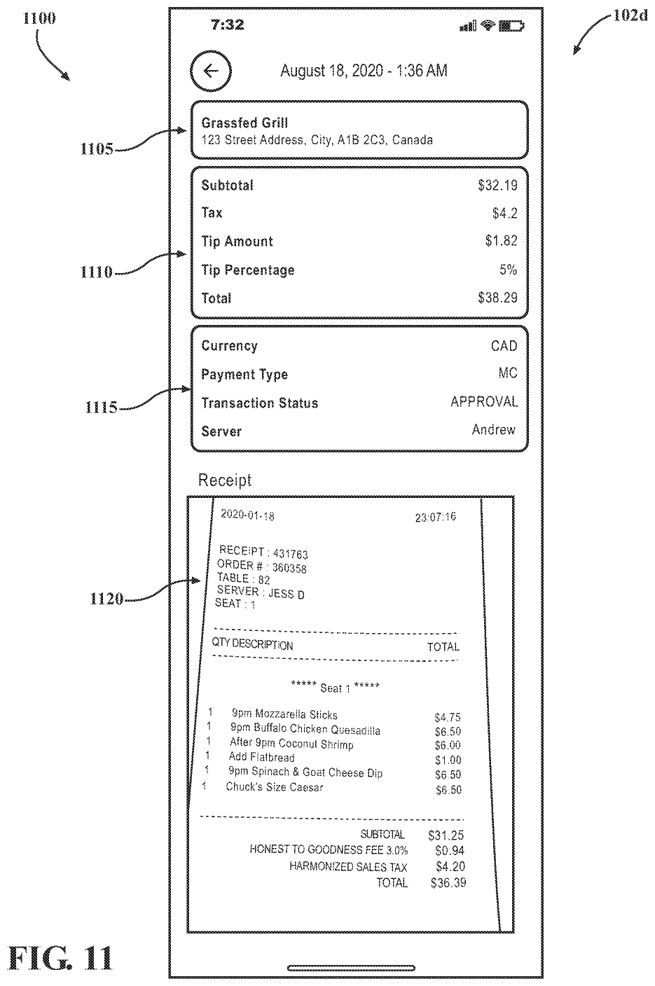

Referring to FIG. 11, an illustrative view of a specific transaction interface 1100 displayed on the mobile computing device 102d is schematically depicted. The specific transaction interface 1100 includes a restaurant section 1105, which provides information about the restaurant, a total price section 1110, a payment status section 1115, and a receipt section 1120. The total price section 1110 includes a subtotal price or amount of the OCR receipt, a tax amount, a tip amount, a tip percentage and a total amount. The payment status section 1115 includes a currency type, such as Canadian (CAD) or U.S. ($), a payment type, such as Visa®, MasterCard®, and the like. A transaction status and the name of the server employee of the restaurant. The receipt section 1120 includes a scanned copy of the actual bill from the restaurant. This may be directly uploaded by the user via the mobile computing device 102d and/or an electronic copy provided by the restaurant via e-mail, sms text message, a link, and/or the like. In some embodiments, a tip amount is also added to the image of the scanned copy of the actual bill, such that an actual real time receipt is generated.

Referring to FIG. 12, an illustrative view of the transaction history interface 1200 displayed on the mobile computing device 102d is schematically depicted. The transaction history interface 1200 includes a list of recent transactions 1205 that may be adjusted to meet a user needs. For example, it could be the last 10 transaction, the last month, last week, the current week, annual, and the like. As such, a slider 1240 may be used to slide through the transactions. As illustrated, the name of the restaurant, the date, the time, and the amount is displayed for each restaurant graphic 1210. It should be appreciated that each transaction, 1215, 1220, 1225, 1230, and 1235 includes the name of the restaurant, the date, the time, and the amount paid. Further, the transaction history interface 1200 includes the restaurant graphic 665, the dashboard graphic 670, and the transaction history graphic 675.

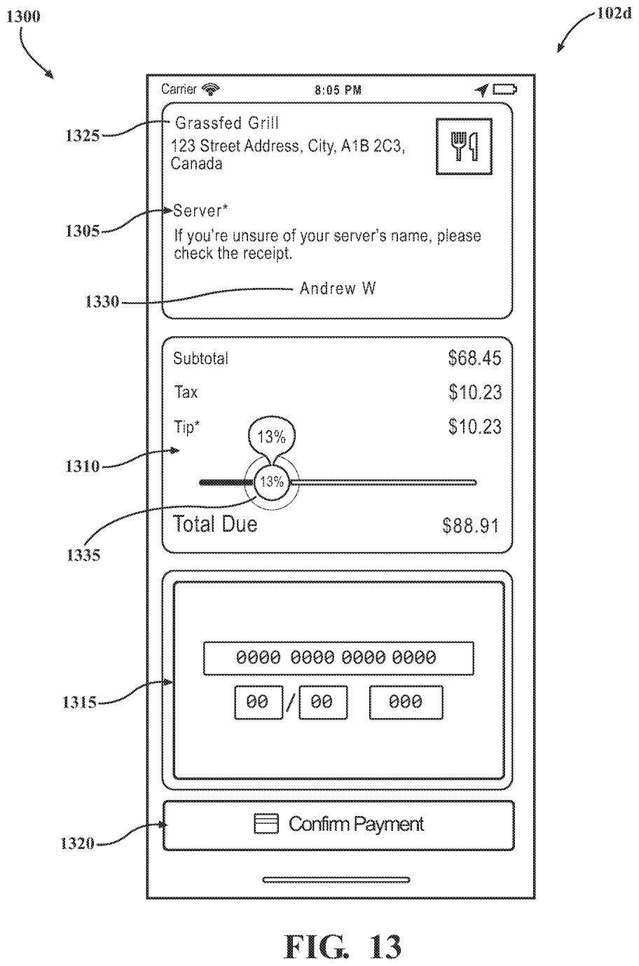

Referring to FIG. 13, an illustrative view of a payment interface 1300 displayed on the mobile computing device 102d is schematically depicted. The payment interface 1300 includes a restaurant section 1305, which includes a name and address of the restaurant 1325 and the name of the servicer employee 1330, which is data gathered from OCR of the bill. Further, the payment interface 1300 includes a subtotal amount of the bill section 1310. This section further includes a slider bar 1335 to easily adjust a tip percentage, which is calculated and displayed in the subtotal amount of the bill section 1310 for the user to easily identify a total due of the bill. The slider bar 1335 is configured for the user to conveniently slide back and forth to raise/decrease the tip the user desires. Further, an overall total due displayed changes with the tip amount. The payment interface 1300 further includes a payment section 1315 where the user may enter payment information and a confirm payment graphic button 1320 that begins the payment process for the total due when selected.

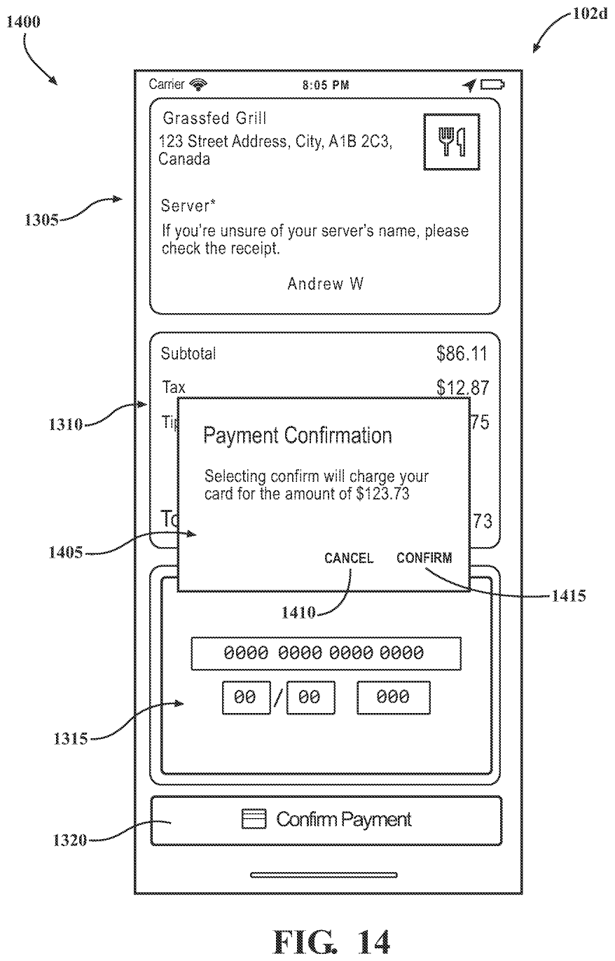

Referring to FIG. 14, an illustrative view of a payment confirmation interface 1400 displayed on the mobile computing device 102d is schematically depicted. The payment confirmation interface 1400 includes a popup confirmation graphic 1405 that asks the user to confirm the total amount with a confirm graphic 1415 or cancel the transaction via a cancel graphic 1410.

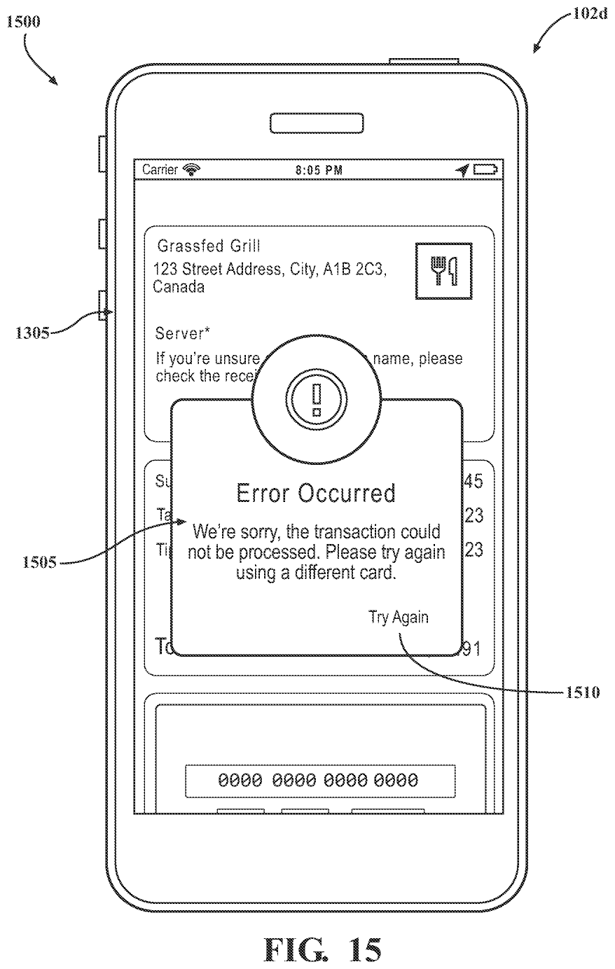

Referring to FIG. 15, an illustrative view of an unsuccessful payment notification interface 1500 displayed on the mobile computing device 102d is schematically depicted. The unsuccessful payment notification interface 1500 includes a popup error graphic 1505 that informs the user of a failed transaction and asks the user to try again via a try again graphic 1510.

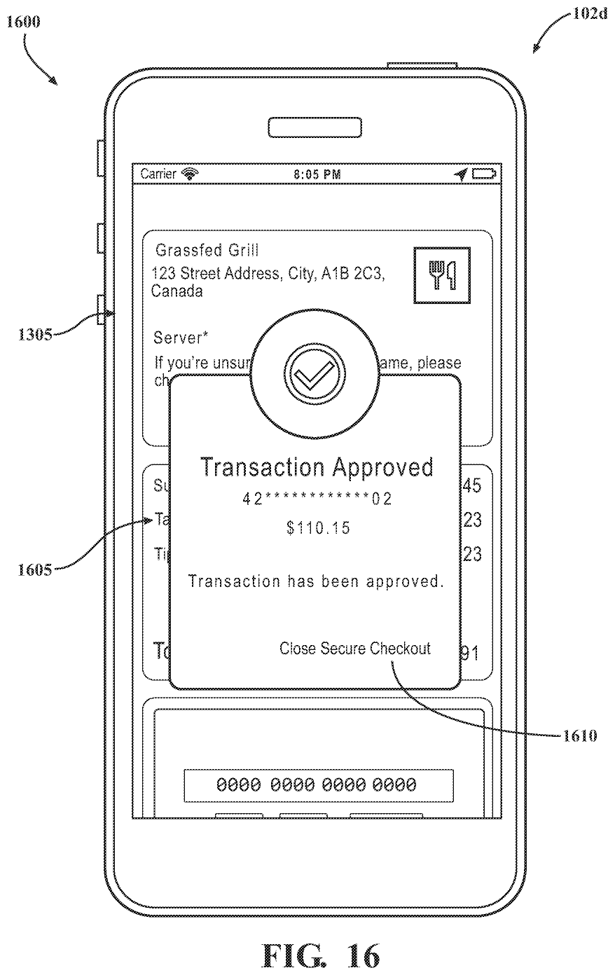

Referring to FIG. 16, an illustrative view of a payment successful interface 1600 displayed on the mobile computing device 102d is schematically depicted. The payment successful interface 1600 includes a popup confirmation graphic 1605 that notifies the user of the transaction approval. The popup confirmation graphic 1605 includes a close secure checkout graphic 1610 to exit the payment display.

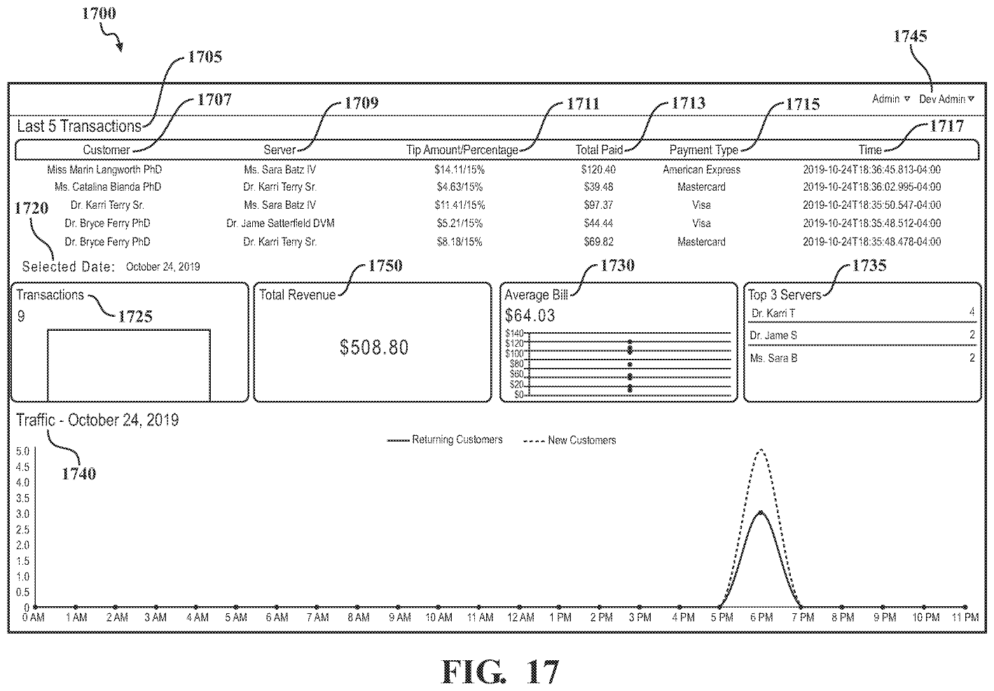

Now referring to FIG. 17, an illustrative view of a restaurant portal interface 1700 displayed on the restaurant computing device 102a is schematically depicted. The restaurant portal interface may be configured for the restaurant to view the transactions that are processed through each mobile computing device 102d. In some embodiments, the restaurant portal interface may be a paid subscription and/or the restaurant computing device 102a may be configured to only work in the system 100 and/or may require a restaurant to purchase a restaurant computing device 102a that is dedicated for use in the system 100.

In some embodiments, the restaurant portal interface 1700 uses websockets so as soon as a new transaction goes through the system 100, the restaurant portal interface 1700 automatically refreshes the data to reflect the newest information such that the restaurant does not have to manually intervene. The restaurant portal interface 1700 provides the last five processed transaction 1705. The last five processed transactions may include a customer name 1707, the server name 1709, a tip amount and/or percentage 1711, a total paid 1713, a payment type 1715, a time 1717, and the like. It should be appreciated that this information is provided by the system 100 and may be provided by communication between the mobile computing device 102d, the interface server device 102b, and/or the restaurant computing device 102a via the network 101.

Further, in some embodiments, the restaurant portal interface 1700 provides an ability to select a date 1720 that displays the transaction (sales) for the selected date. The restaurant portal interface 1700 may display a graph that graphically displays the number of transactions per hour 1725, a graph that graphically displays all of the transaction amounts based on time and total price for the selected date 1730, and list of the top three servers for the selected day 1735. It is understood that the top three servers may be determined based on the based on total number tables served that paid using the system 100. Further, the restaurant portal interface 1700 may include a graph 1740 that graphically displays the traffic for the selected date at the restaurant. The graph 1740 may display an hour by hour count of traffic, the number of guests, of the guests, who the number of new guests and the number of repeat guests, and the like.

Further yet, in some embodiments, the restaurant portal interface 1700 may be configured based on the user 1745. For instance, the restaurant portal interface 1700 may display a total revenue for the current day 1750 when the user is a member of management, owners, and the like, whereas servers may instead see how many tables they served.

It should be appreciated that the restaurant receives payment via commonly used POS practices. Further, the restaurant receives live or real time notification that the bill was paid as well as transaction reports that may be customize for each restaurant.

Additional pages of the system 100 to be displayed on either the mobile computing device 102d, the administrative computing device 102c, and/or the restaurant computing device 102a such as a restaurant index. The restaurant index may be an interface that allows users to see all of the restaurants in the system 100, or if they have allowed for location services. It should be appreciated that the displayed restaurants may be limited to a predetermine radius determined from the user's location to help narrow down results. When a restaurant is selected, the system 100 directs the user to the restaurant selection interface 800 (FIG. 8), as discussed above.

Another additional page of the system 100 that may be displayed on the mobile computing device 102d, the administrative computing device 102c and/or the restaurant computing device 102a may be a transaction index. The transaction index may be an index that displays all past transactions that the user has made with the restaurant name, date, and total. Yet another additional interface may be a transaction interface. The transaction interface may be displayed on the mobile computing device 102d, the administrative computing device 102c and/or the restaurant computing device 102a and may display the specific details of the transaction, the subtotal amount, total amount, tax amount, tip amount/percentage, the restaurant, the restaurant logo, a picture of the receipt uploaded and/or generated, and the like.

It should be appreciated that the disclosed systems and methods are configured for mobile restaurant payments. The system is configured to determine the location of a restaurant a user is present within, to read a scanned bill and to generate a receipt, to accept a payment and to process the payment including transferring the funds to the restaurant without the need for a server or the restaurant to intervene. Further, the systems and methods for mobile restaurant payments provides real time reporting and analysis for the user based on a plurality of transactions completed using the mobile restaurant payment system and methods.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A restaurant payment system comprising:
a mobile computing device; and
an interface server device communicatively coupled to the mobile computing device, the interface server device including:
a processing device, and
a non-transitory, processor-readable storage medium in communication with the processing device, the non-transitory, processor-readable storage medium having one or more programming instructions that, when executed, cause the processing device to:
receive, by the mobile computing device, a location of a dining service,
display, on the mobile computing device, a plurality of restaurants located within a predetermined radius of the determined location,
receive, by the mobile computing device, a bill for the dining service,
determine a plurality of information included on the bill, and
display, on the mobile computing device, the plurality of information included on the bill.

2. The restaurant payment system of claim 1, wherein:
the bill is captured as an image and uploaded from the mobile computing device to the interface server device, and
the interface server device alters the image to reduce an overall file size, brighten the image, and increase a sharpness of the image.

3. The restaurant payment system of claim 2, wherein the image is scanned to determine the plurality of information included on the bill by an optical character recognition algorithm.

4. The restaurant payment system of claim 3, wherein the non-transitory, processor-readable storage medium further having one or more programming instructions that, when executed, cause the processing device to:
determine an accuracy of the image using a plurality of predetermined factors.

5. The restaurant payment system of claim 4, wherein the plurality of predetermined factors include a clarity of the image, a quality of the image, and a light and darkness of the image.

6. The restaurant payment system of claim 3, wherein the plurality of information includes a subtotal price for the bill, a server name, and a plurality of restaurant information.

7. The restaurant payment system of claim 1, wherein the non-transitory, processor-readable storage medium further having one or more programming instructions that, when executed, cause the processing device to:
display, on the mobile computing device, a slider that is movable by a user to select a tip amount,
wherein the tip amount changes a visual graphic of a total amount due.

8. The restaurant payment system of claim 7, wherein a percentage of the tip amount is displayed when the slider is moved by the user.

9. The restaurant payment system of claim 7, wherein the non-transitory, processor-readable storage medium further having one or more programming instructions that, when executed, cause the processing device to:
receive, from the mobile computing device, a payment information,
receive, from the mobile computing device, a confirmation payment information,
transmit the payment information to process a restaurant payment,
receive a transaction approval for the restaurant payment,
notify an approved transaction to a restaurant computing device, and
store the transaction approval for the mobile computing device.

10. A method for restaurant payment, the method comprising:
receiving, by a mobile computing device, a location of a dining service;
displaying, on the mobile computing device, a plurality of restaurants located within a predetermined radius;
receiving, by the mobile computing device, a bill for the dining service;
determining, by an interface server device, an accuracy of the image using a plurality of predetermined factors;
determining, by the interface server device, a plurality of information included on the bill; displaying, on the mobile computing device, the plurality of information included on the bill; and
displaying, on the mobile computing device, a slider that is movable by a user to select a tip amount,
wherein the tip amount changes a visual graphic of a total amount due.

11. The method of claim 10, wherein:
the bill is captured as an image and uploaded from the mobile computing device to the interface server device, and
the interface server device alters the image to reduce an overall file size, brighten the image, and increase a sharpness of the image.

12. The method of claim 11, wherein the image is scanned to determine the plurality of information included on the bill by an optical character recognition algorithm.

13. The method of claim 12, wherein the plurality of predetermined factors include a clarity of the image, a quality of the image, and a light and darkness of the image.

14. The method of claim 13, wherein the plurality of information includes a subtotal price for the bill, a server name, and a plurality of restaurant information.

15. The method of claim 10, wherein a percentage of the tip amount is displayed when the slider is moved by the user.

16. The method of claim 14, further comprising:
receiving, from the mobile computing device, a payment information;
receiving, from the mobile computing device, a confirmation payment information;
transmitting, by the interface server device, the payment information to process the restaurant payment;
receiving, by the interface server device, a transaction approval for the restaurant payment;
notifying, by the interface server device, an approved transaction to a restaurant computing device; and
storing, on the interface server device, the transaction approval for the mobile computing device.

17. A system for wirelessly completing a restaurant payment comprising:
a mobile computing device;
a restaurant computing device communicatively coupled to the mobile computing device; and
an interface server device communicatively coupled to the mobile computing device and the restaurant computing device including:
a processing device; and
a non-transitory, processor-readable storage medium in communication with the processing device, the non-transitory, processor-readable storage medium having one or more programming instructions that, when executed, cause the processing device to:
receive, by the mobile computing device, a payment initiation,
transmit, by the interface server device, a payment information,
collect, by the interface server device, a plurality of funds that correspond to the payment information less any fees, and
transfer, by the interface server device, the plurality of funds that correspond to the payment information less any fees to the restaurant computing device.

18. The system of claim 17, wherein the mobile computing device is notified of the collecting of the plurality of funds that correspond to the payment information.

19. The system of claim 18, wherein the restaurant computing device is notified of the collecting of the plurality of funds that correspond to the payment information.

20. The system of claim 19, wherein the interface server device stores the payment information under a user of the mobile computing device.
